(19) United States
(12) Patent Application Publication
(10) Pub. No.: US 2026/0145681 A1
(43) Pub. Date: May 28, 2026

(54) VEHICLE CONTROL DEVICE, REINFORCEMENT LEARNING METHOD, REINFORCEMENT LEARNING DEVICE, AND NON-TRANSITORY COMPUTER- READABLE STORAGE MEDIUM

(71) Applicant: HONDA MOTOR CO., LTD., Tokyo (JP)

(72) Inventors: Kazuki OGAWA, Saitama (JP); Rintaro IMAMURA, Saitama (JP); Takeru GOTO, Saitama (JP)

(21) Appl. No.: 19/366,840

(22) Filed: Oct. 23, 2025

(30) Foreign Application Priority Data
Nov. 28, 2024 (JP) 2024-207208

(51) Int. Cl. B60W 30/18; B60W 10/04; B60W 10/18; B60W 10/20; B60W 30/09; B60W 50/00; G05B 13/02

(52) U.S. Cl. CPC B60W 30/18163; B60W 10/04; B60W 10/18; B60W 10/20; B60W 30/09; B60W 50/0098; G05B 13/027; B60W 2050/0028; B60W 2552/10; B60W 2710/182; B60W 2710/207; B60W 2720/106

(57) ABSTRACT

A vehicle control device for performing merging control of a vehicle includes: a surrounding environment recognition unit that recognizes surrounding environment of the vehicle; an ego vehicle state recognition unit that recognizes an ego vehicle state which is a state of the vehicle; a travel plan unit that successively inputs the surrounding environment and the ego vehicle state to a trained model that outputs a target merging position in response to input of the surrounding environment and the ego vehicle state, whereby the travel plan unit successively acquires the target merging position and creates a travel plan of the vehicle based on a latest value of the target merging position; and a travel control unit that controls acceleration, deceleration, and steering of the vehicle based on the travel plan, without relying on an operation by an occupant.

### TECHNICAL FIELD

The present invention relates to a vehicle control device and a reinforcement learning method.

### BACKGROUND ART

In recent years, there has been an increase in efforts to provide sustainable transportation systems that take into account people in vulnerable situations among traffic participants. To realize this, research and development related to driving assistance technology and autonomous driving technology are conducted to further improve the safety and convenience of traffic.

JP2017-165197A discloses a vehicle control device for enabling a vehicle traveling on a side road to smoothly merge into vehicles traveling on a main road in a merging area where the side road merges with the main road. The vehicle control device acquires the positions of the vehicles traveling on the main road, sets a target merging position based on the position of each vehicle, and automatically controls acceleration and deceleration of the vehicle toward the target merging position.

However, the vehicles traveling on the main road may behave in an unexpected manner. Therefore, the target merging position set at one time point may become unsuitable for merging after a few seconds.

### SUMMARY OF THE INVENTION

In view of the foregoing background, one object of the present invention is to provide a vehicle control device capable of performing optimal merging control according to a change in the situation. Another object of the present invention is to provide a reinforcement learning method for generating a trained model used by the vehicle control device. Thereby, the present invention contributes to development of a sustainable transportation system.

To achieve the above object, one aspect of the present invention provides a vehicle control device for performing merging control of a vehicle, the vehicle control device comprising: a surrounding environment recognition unit that recognizes surrounding environment of the vehicle; an ego vehicle state recognition unit that recognizes an ego vehicle state which is a state of the vehicle; a travel plan unit that successively inputs the surrounding environment and the ego vehicle state to a trained model that outputs a target merging position in response to input of the surrounding environment and the ego vehicle state, whereby the travel plan unit successively acquires the target merging position and creates a travel plan of the vehicle based on a latest value of the target merging position; and a travel control unit that controls acceleration, deceleration, and steering of the vehicle based on the travel plan, without relying on an operation by an occupant.

Another aspect of the present invention provides a reinforcement learning method executed by a computer to generate a trained model that outputs a target merging position in response to an input including surrounding environment of a vehicle and an ego vehicle state which is a state of the vehicle, the reinforcement learning method comprising: acquiring state information including the surrounding environment and the ego vehicle state from a simulator; generating an action plan by a neural network using the state information as an input; executing an action according to the action plan and receiving a reward and next state information; and updating parameters of the neural network based on the reward and the state information and adjusting the action plan, wherein the reward is determined based on multiple auxiliary rewards that are set according to multiple different objectives.

Another aspect of the present invention provides a reinforcement learning device for generating a trained model that outputs a target merging position in response to an input including surrounding environment of a vehicle and an ego vehicle state which is a state of the vehicle, the reinforcement learning device comprising: a simulator that outputs state information including the surrounding environment and the ego vehicle state; and an agent that generates an action plan by a neural network using the state information as an input, executes an action according to the action plan, receives a reward and next state information, updates parameters of the neural network based on the reward and the state information, and adjusts the action plan, wherein the reward is determined based on multiple auxiliary rewards that are set according to multiple different objectives.

Another aspect of the present invention provides a non-transitory computer-readable storage medium, comprising a stored program, the program configured to cause a computer to execute a reinforcement learning method for generating a trained model that outputs a target merging position in response to an input including surrounding environment of a vehicle and an ego vehicle state which is a state of the vehicle, the reinforcement learning method comprising: acquiring state information including the surrounding environment and the ego vehicle state from the simulator; generating an action plan by a neural network using the state information as an input; executing an action according to the action plan and receiving a reward and next state information; and updating parameters of the neural network based on the reward and the state information and adjusting the action plan, wherein the reward is determined based on multiple auxiliary rewards that are set according to multiple different objectives.

According to the above aspects of the present invention, a vehicle control device capable of conducting an optimal merging control according to a change in the situation can be provided. Also, a reinforcement learning device, a reinforcement learning method, and a program for training a trained model used in the vehicle control device can be provided.

### BRIEF DESCRIPTION OF THE DRAWINGS

FIG. 1 is a configuration diagram of a vehicle control device according to an embodiment;

FIG. 2 is an explanatory diagram of a merging area;

FIG. 3 is a flowchart of merging control executed by the vehicle control device;

FIG. 4 is a configuration diagram of a learning device according to the embodiment;

FIG. 5 is a diagram conceptually showing a model structure of DQN;

FIG. 6 is a graph showing a first reward; and

FIG. 7 is a graph showing a third reward.

### DETAILED DESCRIPTION OF THE INVENTION

In the following, embodiments of a vehicle control device, a reinforcement learning method, a reinforcement learning device, and a program will be described with reference to the drawings.

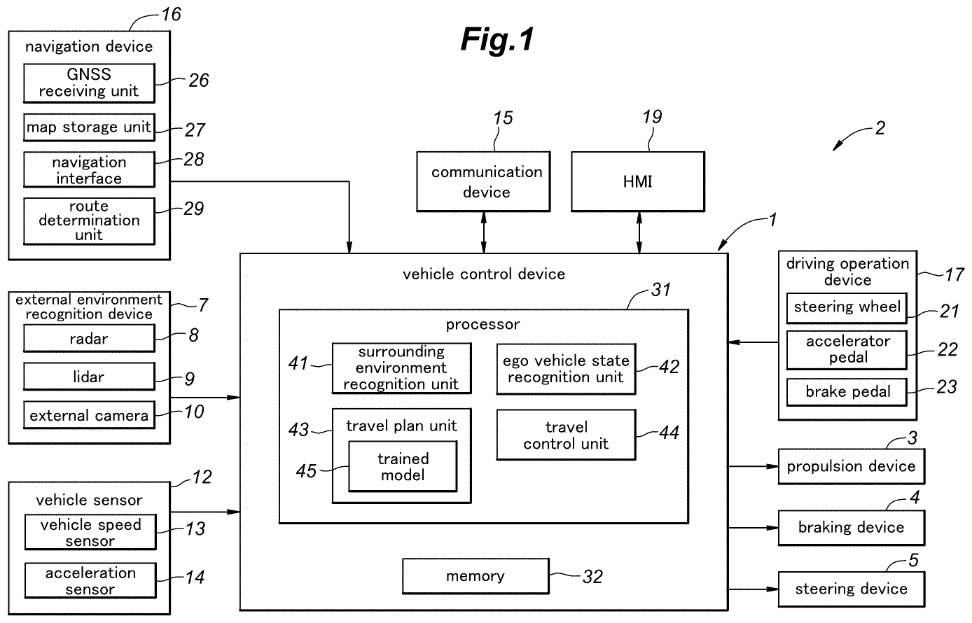

As shown in FIG. 1, a vehicle control device 1 is provided in a vehicle 2. The vehicle 2 may be a four-wheeled automobile, for example. The vehicle 2 is an autonomous vehicle or a vehicle with a driving assistance function.

The vehicle 2 includes a propulsion device 3, a braking device 4, and a steering device 5. The propulsion device 3 is a device for providing a driving force to the vehicle 2 and includes a power source and a transmission, for example. The power source includes at least one of an internal combustion engine, such as a gasoline engine or a diesel engine, and an electric motor. The braking device 4 is a device for applying a braking force to the vehicle 2 and includes a brake caliper for pressing a pad against a brake rotor and an electric cylinder for supplying hydraulic pressure to the brake caliper, for example. The steering device 5 is a device for changing the steering angle of the wheels and includes a rack-and-pinion mechanism for steering the wheels and an electric motor for driving the rack-and-pinion mechanism, for example. The propulsion device 3, the braking device 4, and the steering device 5 are controlled by the vehicle control device 1.

The vehicle 2 includes an external environment recognition device 7. The external environment recognition device 7 is a device that detects objects or the like outside the vehicle 2. The external environment recognition device 7 is a sensor that detects objects or the like outside the vehicle 2 by capturing electromagnetic waves or light from the surroundings of the vehicle 2. The external environment recognition device 7 includes a radar 8, a lidar 9, and an external camera 10, for example.

The vehicle 2 includes a vehicle sensor 12. The vehicle sensor 12 includes a vehicle speed sensor 13 that detects the speed of the vehicle 2 and an acceleration sensor 14 that detects the acceleration of the vehicle 2. The vehicle sensor 12 may include a yaw rate sensor that detects an angular velocity around a vertical axis, a direction sensor that detects the direction of the vehicle 2, etc.

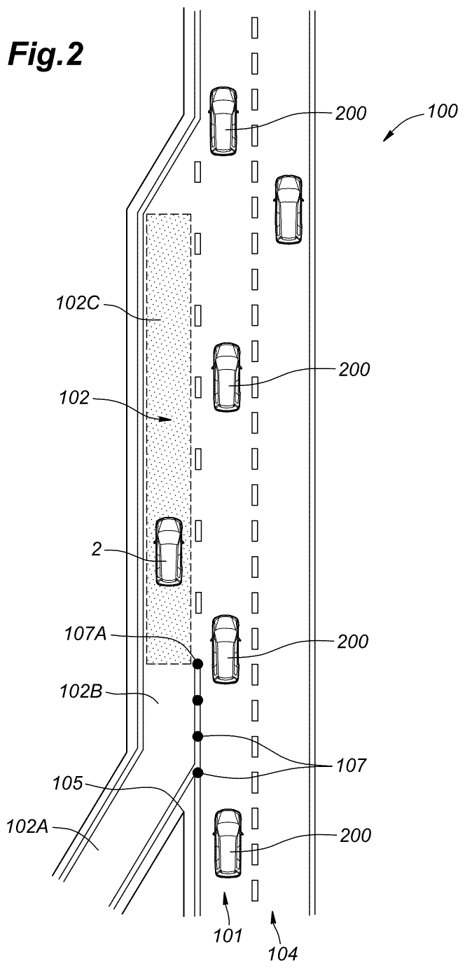

The vehicle 2 includes a communication device 15, a navigation device 16, a driving operation device 17, and a human machine interface (HMI) 19. The communication device 15 mediates the communication of the vehicle control device 1 and the navigation device 16 with the nearby vehicles 200 (see FIG. 2) and a server located outside the vehicle 2.

The navigation device 16 is a device that acquires the current position of the vehicle 2 and provides route guidance to the destination and other functions. The navigation device 16 preferably includes a global navigation satellite system (GNSS) receiving unit 26, a map storage unit 27, a navigation interface 28, and a route determination unit 29. The GNSS receiving unit 26 identifies the position (latitude and longitude) of the vehicle 2 based on signals received from artificial satellites (positioning satellites). The map storage unit 27 is composed of a known storage device such as a flash memory or a hard disk and stores map information. The navigation interface 28 receives inputs, such as the destination, from the occupant, and presents various kinds of information to the occupant by display and/or voice. The navigation interface 28 is preferably a touch panel display, for example.

The driving operation device 17 receives input operations performed by the occupant (driver) to control the vehicle 2. The driving operation device 17 includes a steering wheel 21, an accelerator pedal 22, and a brake pedal 23. Also, the driving operation device 17 may include a shift lever, a parking brake lever, and the like. Each of these elements of the driving operation device 17 is provided with a sensor for detecting an operation amount thereof. The driving operation device 17 outputs a signal indicating the operation amount of each element to the vehicle control device 1.

The HMI 19 notifies the occupant of various kinds of information by display and/or voice and receives input operations performed by the occupant. The HMI 19 may be a touch panel display including a liquid crystal display, an organic EL display, or the like.

The vehicle control device 1 is a computer including a processor 31 and a memory 32 communicatively connected to the processor 31. The processor 31 preferably includes, as a core, at least one of a central processing unit (CPU), a graphics processing unit (GPU), and a reduced instruction set computer (RISC), for example. The memory 32 stores a control program executed by the processor 31 and various data. The memory 32 preferably includes at least one of a volatile memory and a non-volatile memory. The volatile memory may be a dynamic random access memory (DRAM) or a static random access memory (SRAM), for example. The non-volatile memory may be a solid state drive (SSD), a flash memory, a magnetic disk storage device, or an optical disk storage device. At least a part of the vehicle control device 1 may be realized by hardware such as a large scale integration (LSI) circuit, an application specific integrated circuit (ASIC), or a field-programmable gate array (FPGA) or may be realized by a combination of software and hardware. The vehicle control device 1 may be composed of one piece of hardware or may be composed of multiple pieces of hardware capable of communicating with each other. A part of the vehicle control device 1 may be configured by an external server provided outside the vehicle 2.

The processor 31 implements various applications by executing the program stored in the memory 32. The program may be stored in a removable recordable medium such as a DVD or a CD-ROM and may be installed into the memory 32 when the recordable medium is read by a reading device. Also, the program may be downloaded via a communication network such as the internet and installed into the memory 32.

By executing the program stored in the memory 32, the processor 31 functions as a surrounding environment recognition unit 41, an ego vehicle state recognition unit 42, a travel plan unit 43, and a travel control unit 44.

The surrounding environment recognition unit 41 recognizes the surrounding environment of the vehicle 2. The surrounding environment recognition unit 41 recognizes, based on the detection result of the external environment recognition device 7, the surrounding environment (external environment) including obstacles present around the vehicle 2, road shape, lane markings, presence or absence of sidewalks, road markings, etc. The obstacles include guardrails, utility poles, nearby vehicles 200 (see FIG. 2), and persons such as pedestrians, for example. The surrounding environment recognition unit 41 can acquire a state, such as the position, velocity, and acceleration of each nearby vehicle 200 from the detection result of the external environment recognition device 7. In a merging area 100 shown in FIG. 2, the surrounding environment recognition unit 41 recognizes, as the surrounding environment, a mergeable area 102C and the position and velocity of each of the multiple nearby vehicles 200.

As shown in FIG. 2, the merging area 100 includes a main lane 101 and a merging lane 102 that merges with the main lane 101. The main lane 101 may be an outside lane of a main road 104 including multiple lanes. Note that the main road 104 may be constituted of only the main lane 101. In the main lane 101 and the merging lane 102, a forward direction is defined as the traveling direction of the vehicle 2. The main lane 101 may extend linearly or may be curved. The merging area 100 may constitute a part of an expressway.

The merging lane 102 includes a first part 102A, a second part 102B, and a mergeable area 102C in order toward the front. The first part 102A is separated from the main lane 101 by a hard nose 105. The first part 102A may be disposed to be spaced from the main lane 101. Also, the first part 102A may be inclined relative to the main lane 101. A side portion of the front end of the first part 102A is preferably joined to a side portion of the main lane 101. The hard nose 105 is preferably formed of structural members such as walls or guardrails, for example.

The second part 102B extends along the main lane 101. The road surface of the second part 102B is preferably connected to the road surface of the main lane 101 in the lateral direction. At the boundary between the main lane 101 and the second part 102B of the merging lane 102, a regulating body 107 is provided. The regulating body 107 regulates the movement of the vehicle 2 from the merging lane 102 to the main lane 101. The regulating body 107 may be continuous or may be provided intermittently along the boundary between the main lane 101 and the merging lane 102. The regulating body 107 is preferably composed of structural members such as multiple traffic poles, traffic cones, road tacks, or curbs, for example. Between the multiple traffic poles, a guard rope may be stretched. The regulating body 107 may also be called a soft nose. The front end of the regulating body 107 is referred to as a regulating body end 107A.

The mergeable area 102C extends along the main lane 101. The mergeable area 102C constitutes an ending portion of the merging lane 102. In the mergeable area 102C, the vehicle 2 can change lanes from the merging lane 102 to the main lane 101, namely, can merge into the main lane 101. The beginning point of the mergeable area 102C preferably coincides with the regulating body end 107A. The ending point of the mergeable area 102C is preferably a position where the width of the merging lane 102 begins to narrow.

The surrounding environment recognition unit 41 acquires the positions of the beginning and ending points of the mergeable area 102C and the position and velocity of each of the multiple nearby vehicles 200 traveling on the main lane 101. The position of each nearby vehicle 200 is preferably a position with respect to the beginning point of the mergeable area 102C. Note that the reference position for each nearby vehicle 200 is not limited to the beginning point of the mergeable area 102C, and may be changed arbitrarily. For example, the reference position may be the tip of the hard nose 105, the ending point of the mergeable area 102C, or the midpoint between the beginning point and the ending point of the mergeable area 102C. The surrounding environment recognition unit 41 recognizes all nearby vehicles 200 positioned within a predetermined range forward and rearward of the vehicle 2.

The ego vehicle state recognition unit 42 recognizes an ego vehicle state which is a state of the vehicle 2 (ego vehicle). The ego vehicle state includes the position of the vehicle 2 and the velocity of the vehicle 2. The position of the vehicle 2 is preferably a position with respect to the beginning point of the mergeable area 102C. The ego vehicle state recognition unit 42 preferably acquires the velocity of the vehicle 2 based on the signal from the vehicle speed sensor 13. Preferably, the ego vehicle state recognition unit 42 recognizes the position of the regulating body end 107A based on the detection result of the external environment recognition device 7, and recognizes the position of the vehicle 2 with respect to the beginning point of the mergeable area 102C based on the position of the regulating body end 107A. The ego vehicle state recognition unit 42 may acquire the position of the vehicle 2 with respect to the beginning point of the mergeable area 102C based on the map information and the position of the vehicle 2 acquired based on the GNSS signal received by the GNSS receiving unit 26.

The travel plan unit 43 creates a travel plan of the vehicle 2. The travel plan unit 43 sequentially creates a travel plan for causing the vehicle 2 to autonomously travel along the route. More specifically, the travel plan unit 43 first determines autonomous driving events for causing the vehicle 2 to travel on the target lane determined by the route determination unit 29 without coming into contact with an obstacle. Based on the events determined, the travel plan unit 43 generates a target trajectory on which the vehicle 2 should travel in future. The target trajectory is a sequence of trajectory points, which are points where the vehicle 2 should reach at each time point. Preferably, the travel plan unit 43 generates the target trajectory, the target speed, and the target acceleration for each event. The autonomous driving events may include a constant speed traveling event, a preceding vehicle following event, a lane changing event, a diverging event, a merging event, a passing event, etc.

The travel plan unit 43 generates a merging event when the vehicle 2 is traveling on the merging lane 102. The travel plan unit 43 preferably determines that the vehicle 2 is traveling on the merging lane 102 based on the position of the vehicle 2 and the map information.

In the merging event, the travel plan unit 43 successively inputs the surrounding environment and the ego vehicle state to a trained model 45 that outputs a target merging position in response to input of the surrounding environment and the ego vehicle state, whereby the travel plan unit 43 successively acquires the target merging position and creates a travel plan of the vehicle 2 based on the latest value of the target merging position. The trained model 45 is a model that has been trained with reinforcement learning which is one kind of machine learning.

The trained model 45 outputs a target merging position in response to an input including the surrounding environment and the ego vehicle state. The target merging position is a position where the vehicle 2 traveling on the merging lane 102 starts lane changing to the main lane 101. The target merging position is preferably a position with respect to the beginning point of the mergeable area 102C. The input including the surrounding environment and the ego vehicle state preferably includes at least the position of the vehicle 2 (first input data), the length of the mergeable area 102C (second input data), the velocity of the vehicle 2 (third input data), the position of each nearby vehicle 200 (fourth input data), the velocity of each nearby vehicle 200 (fifth input data), and the previous target merging position (sixth input data).

The position of the vehicle 2, which is the first input data, is preferably a position with respect to the beginning point of the mergeable area 102C. The position of the vehicle 2 may be calculated based on the position of the regulating body end 107A (the beginning point of the mergeable area 102C) acquired by the surrounding environment recognition unit 41 and the position of the vehicle 2 acquired by the ego vehicle state recognition unit 42.

The length of the mergeable area 102C, which is the second input data, is preferably normalized based on a maximum mergeable area length that is expected. The length of the mergeable area 102C may be calculated according to the following formula (1).

$${L}_{norm} = L / {L}_{max} \qquad ( 1 )$$

Here, L is the length of the mergeable area 102C (the distance between the beginning point and the ending point of the mergeable area 102C), Lₙₒᵣₘ is the normalized length of the mergeable area 102C, and Lₘₐₓ is the maximum mergeable area length. The maximum mergeable area length is preferably a preset fixed value. The distance between the beginning point and the ending point of the mergeable area 102C may be calculated based on the positions of the beginning point and the ending point of the mergeable area 102C acquired by the surrounding environment recognition unit 41.

The velocity of the vehicle 2, which is the third input data, is preferably normalized based on the merging lane speed limit. The normalized velocity of the vehicle 2 may be calculated according to the following formula (2).

$${V}_{norm \_ ego} = {V}_{ego} / {V}_{L 1} \qquad ( 2 )$$

Here, V_{ego} is the velocity of the vehicle 2 [km/h], V_{L1} is the merging lane speed limit [km/h], and V_{norm_ego} is the velocity of the vehicle 2 normalized based on the merging lane speed limit V_{L1}. The merging lane speed limit V_{L1} may be a preset value or may be a value acquired from the map information, signs, or communication network. The velocity of the vehicle 2 is preferably acquired by the ego vehicle state recognition unit 42.

The position of each nearby vehicle 200, which is the fourth input data, includes the positions of the multiple nearby vehicles 200. The position of each nearby vehicle 200 is preferably normalized according to the following formula (3).

$${S}_{norm \_ i} = 0.5 + \frac{{S}_{i} - {S}_{ego}}{R} \qquad ( 3 )$$

Here, Si is the position of the i-th nearby vehicle 200 from the front with respect to the beginning point of the mergeable area 102C, S_{ego} is the position of the vehicle 2 with respect to the beginning point of the mergeable area 102C, R is a distance within which the vehicle 2 can recognize the nearby vehicles 200 (recognizable distance), and S_{norm_i} is the normalized position of the i-th nearby vehicle 200 from the front. The recognizable distance R is preferably a value preset based on the performance of the external environment recognition device 7. The position Si of each nearby vehicle 200 may be calculated based on the position of each nearby vehicle 200 and the position of the regulating body end 107A acquired by the surrounding environment recognition unit 41. The position of the vehicle 2 may be calculated based on the position of the regulating body end 107A acquired by the surrounding environment recognition unit 41.

The velocity of each nearby vehicle 200, which is the fifth input data, is preferably normalized based on the speed limit of the main lane. The normalized velocity of each nearby vehicle 200 may be calculated according to the following formula (4).

$${V}_{norm \_ i} = {V}_{i} / {V}_{L 2} \qquad ( 4 )$$

Here, Vᵢ is a velocity [km/h] of each nearby vehicle 200, V_{L2} is a speed limit [km/h] of the main lane 101, and V_{norm_i} is a normalized velocity of each nearby vehicle 200. The main lane speed limit V_{L2} may be a preset value or may be a value acquired from the map information, signs, or communication network. The velocity of each nearby vehicle 200 is preferably acquired by the surrounding environment recognition unit 41.

As the previous target merging position, which is the sixth input data, the previous target merging position outputted from the trained model 45 is used.

The travel plan unit 43 preferably creates the first to fifth input data to be inputted to the trained model 45 based on the information acquired by the surrounding environment recognition unit 41 and the ego vehicle state recognition unit 42. The fourth input data is preferably created as sequence data in which the positions of the multiple nearby vehicles 200 are arranged in order from that of the foremost one, for example. Also, the fourth input data and the fifth input data are preferably created as sequence data in which the positions and velocities of the nearby vehicles 200 are arranged in order from those of the frontmost one. For example, the fourth input data and the fifth input data may be represented as [the position of the first nearby vehicle 200 from the front, the velocity of the first nearby vehicle 200 from the front, the position of the second nearby vehicle 200 from the front, the velocity of the second nearby vehicle 200 from the front, . . . ]. The sequence length is preferably set at a fixed length. When the number of nearby vehicles 200 is less than the sequence length, 0 may be set where there is no data.

The trained model 45 is generated by being trained with reinforcement learning using the surrounding environment and the ego vehicle state as the input data such that the value based on a reward is maximized. The reward is determined based on multiple auxiliary rewards that are set based on multiple different objectives.

The multiple auxiliary rewards include a first reward r1 that is set to increase as the time to collision (TTC) between the vehicle 2 and the nearby vehicle 200 increases, and a second reward r2 that is set to increase as the deceleration of the vehicle 2 decreases. The multiple auxiliary rewards may further include a third reward r3 that is set to increase as the target merging position is closer to the beginning point of the mergeable area 102C. The multiple auxiliary rewards may further include a fourth reward r4 that is set to increase as the difference between the current value of the target merging position and the previous value of the target merging position decreases. A learning method for generating the trained model 45 will be described later.

The latest first to sixth input data are successively inputted to the trained model 45 at a predetermined time interval, such as 0.1 seconds, for example. The trained model 45 successively outputs a target merging position corresponding to each input.

Based on the latest value of the target merging position successively outputted from the trained model 45, the travel plan unit 43 successively create a travel plan including the target trajectory and the target speed of the vehicle 2 for allowing the vehicle 2 to merge at the target merging position. The travel plan unit 43 updates the travel plan including the target trajectory and the target speed of the vehicle 2 at a predetermined time interval.

The travel control unit 44 controls acceleration, deceleration, and steering of the vehicle 2 based on the travel plan, without relying on an operation by an occupant. Specifically, the travel control unit 44 controls the propulsion device 3, the braking device 4, and the steering device 5 based on the travel plan. When the travel plan is updated, the travel control unit 44 controls the acceleration, deceleration, and steering of the vehicle 2 based on the updated travel plan, without relying on an operation by an occupant. Thereby, the vehicle 2 travels along the latest target trajectory at the latest target speed.

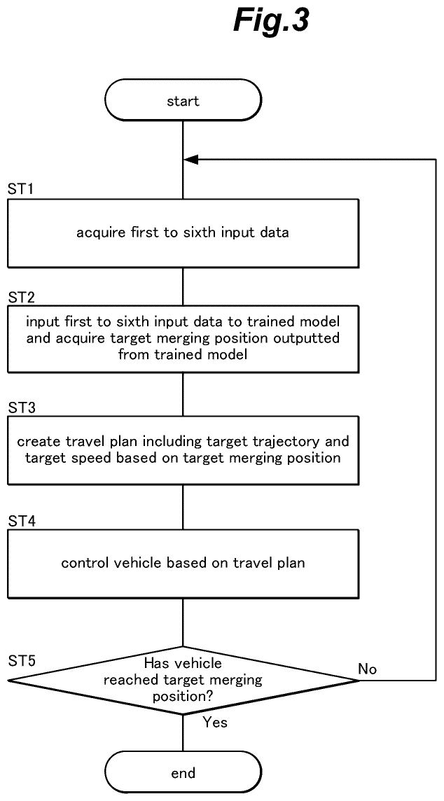

The vehicle control device 1 preferably controls the vehicle 2 based on the control procedure of the merging control shown in FIG. 3. Upon start of the merging event, the travel plan unit 43 first generates the first to sixth input data (ST1). The first to fifth input data are preferably acquired based on the information acquired from the surrounding environment recognition unit 41 and the ego vehicle state recognition unit 42. When the merging event is started, a predetermined initial value is preferably set as the sixth input data. The sixth input data (previous target merging position) is preferably set to a midpoint of the mergeable area 102C, for example.

Next, the travel plan unit 43 inputs the first to sixth input data to the trained model 45 and acquires the target merging position outputted from the trained model 45 (ST2). Subsequently, based on the target merging position, the travel plan unit 43 creates a travel plan including the target trajectory and the target speed of the vehicle 2 for allowing the vehicle 2 to merge at the target merging position (ST3).

Next, the travel control unit 44 controls the propulsion device 3, the braking device 4, and the steering device 5 of the vehicle 2 based on the travel plan including the target trajectory and the target speed of the vehicle 2 (ST4). Namely, the travel control unit 44 performs travel control of the vehicle 2 based on the travel plan.

Next, the travel plan unit 43 determines whether the position of the vehicle 2 acquired from the ego vehicle state recognition unit 42 has reached the target merging position (ST5). In the case where the position of the vehicle 2 has reached the target merging position (ST5: Yes), the process proceeds to the end and stops updating the target merging position. Thereby, the travel control unit 44 controls the propulsion device 3, the braking device 4, and the steering device 5 of the vehicle 2 based on the target trajectory and the target speed of the vehicle 2 set according to the latest target merging position, and thereby causes the vehicle 2 to merge. In the case where the position of the vehicle 2 has not reached the target merging position (ST5: No), the process returns to ST1 and repeats updating the target merging position.

In the vehicle control device 1 described above, since the travel plan unit 43 successively outputs the target merging position at a predetermined time interval by using the trained model 45, it is possible to set an appropriate target merging position according to the movements of the multiple nearby vehicles 200 traveling on the main lane 101. Namely, even when the multiple nearby vehicles 200 make unexpected movements, the vehicle control device 1 can update the target merging position and cause the vehicle 2 to smoothly merge into the main lane 101.

The rewards used when generating the trained model 45 with reinforcement learning include the first reward r1 that is set to increase as the time to collision between the vehicle 2 and the nearby vehicle 200 increases. Thereby, the target merging position is set such that a sufficient time to collision between the vehicle 2 and the nearby vehicle 200 is ensured at the target merging position. As a result, safety of the vehicle 2 when merging improves.

The rewards used when generating the trained model 45 with reinforcement learning include the second reward r2 that is set to increase as the deceleration of the vehicle 2 decreases. Thereby, the target merging position is set such that the deceleration of the vehicle 2 during the travel to the target merging position is suppressed. As a result, the deceleration of the vehicle 2 during the travel to the target merging position is suppressed, and the ride comfort of the vehicle 2 improves.

The rewards used when generating the trained model 45 with reinforcement learning include may include the third reward r3 that is set to increase as the target merging position is closer to the beginning point of the mergeable area 102C. In the case where the third reward r3 is included, the target merging position is set close to the beginning point of the mergeable area 102C. As a result, the merging is completed early, and the psychological burden on the occupant of the vehicle 2 can be reduced.

The rewards used when generating the trained model 45 with reinforcement learning may include the fourth reward r4 that is set to increase as the difference between the current value of the target merging position and the previous value of the target merging position decreases. In the case where the fourth reward r4 is included, the fluctuation of the updated target merging position becomes small, and the travel plan that is set based on the target merging position becomes stable. As a result, behavior of the vehicle 2 when merging becomes stable.

In the following, a reinforcement learning method for generating the trained model 45, a reinforcement learning device 50 for executing the reinforcement learning method, and a program for causing the reinforcement learning device 50 to execute the reinforcement learning method will be described.

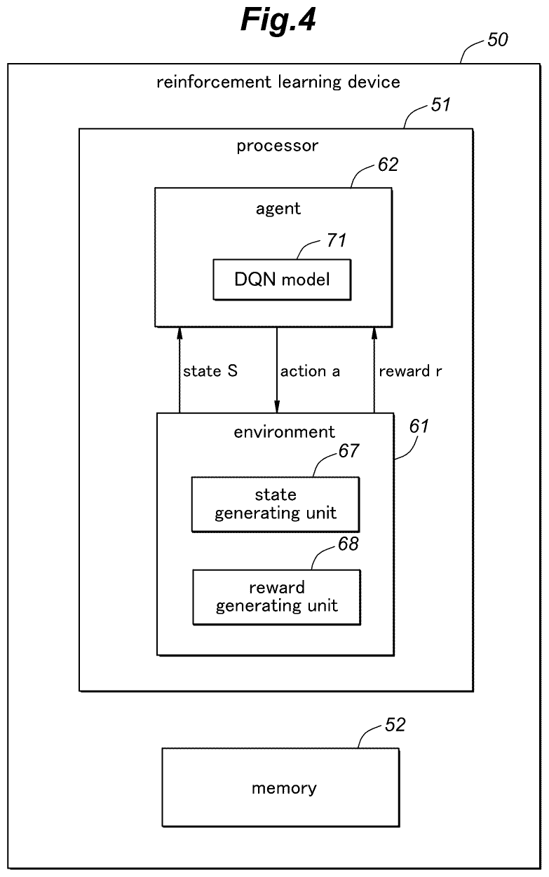

The reinforcement learning method is executed by the reinforcement learning device 50. As shown in FIG. 4, the reinforcement learning device 50 is a computer including a processor 51 and a memory 52 communicatively connected to the processor 51. The processor 51 preferably includes, as a core, at least one of a central processing unit (CPU), a graphics processing unit (GPU), and a reduced instruction set computer (RISC), for example. The memory 52 stores a control program executed by the processor 51 and various data. The memory 52 preferably includes at least one of a volatile memory and a non-volatile memory. The volatile memory may be a dynamic random access memory (DRAM) or a static random access memory (SRAM), for example. The non-volatile memory may be a solid state drive (SSD), a flash memory, a magnetic disk storage device, or an optical disk storage device. At least a part of the reinforcement learning device 50 may be realized by hardware such as a large scale integration (LSI) circuit, an application specific integrated circuit (ASIC), or a field-programmable gate array (FPGA) or may be realized by a combination of software and hardware. The reinforcement learning device 50 may be composed of one piece of hardware or may be composed of multiple pieces of hardware capable of communicating with each other. A part of the reinforcement learning device 50 may be composed of an external server that is located outside.

The processor 51 implements the reinforcement learning method by executing the control program stored in the memory 52. The control program may be stored in a removable recordable medium such as a DVD or a CD-ROM and may be installed into the memory 52 when the recordable medium is read by a reading device. Also, the program may be downloaded via a communication network such as the internet and installed into the memory 52.

The reinforcement learning method according to the present embodiment may use various known reinforcement learning algorithms. The reinforcement learning algorithm may be, for example, Q learning, SARSA, Deep Q Network (DQN), Actor-Critic algorithm, Deep Deterministic Policy Gradient (DDPG), etc. In the present embodiment, as an example, description will be made of the case where DQN, which is one of the deep reinforcement learning algorithms, is used.

As shown in FIG. 4, the processor 51 functions as an environment 61 and an agent 62 by executing the program stored in the memory 52. The agent 62 selects an action based on the information from the environment 61, and performs learning based on the rewards obtained according to the action. The agent 62 receives state information provided from the environment 61, decides an action that the agent 62 should take based on the obtained state information, and performs learning to optimize the action based on experience data (state, action, rewards, next state) obtained from interaction with the environment 61.

The environment 61 is configured by a simulator that simulates the real world. The environment 61 feeds back the result of the action of the agent 62 to the agent 62. The environment 61 includes a state generating unit 67 that generates the next state based on the action inputted from the agent 62, and a reward generating unit 68 that generates a reward based on the state. The state generating unit 67 generates a state including the surrounding environment of the vehicle 2 and the ego vehicle state. Specifically, the state preferably includes at least the position of the vehicle 2 (first input data), the length of the mergeable area 102C (second input data), the velocity of the vehicle 2 (third input data), the position of each nearby vehicle 200 (fourth input data), the velocity of each nearby vehicle 200 (fifth input data), and the previous target merging position (sixth input data).

The reward generating unit 68 determines the reward based on the state. The reward is determined based on multiple auxiliary rewards that are set according to multiple different objectives. The auxiliary rewards include the first to fourth rewards r1 to r4.

The first reward r1 is set to increase as the time to collision between the vehicle 2 and the nearby vehicle 200 increases. The time to collision is a value when the vehicle 2 is at the target merging position. In the case where there are multiple nearby vehicles 200 around the vehicle 2, it is preferred to select the minimum of the times to collision of the vehicle 2 with the respective nearby vehicles 200. The time to collision is preferably calculated based on the position and velocity of the vehicle 2 and the position and velocity of each nearby vehicle 200 when the vehicle 2 is at the target merging position.

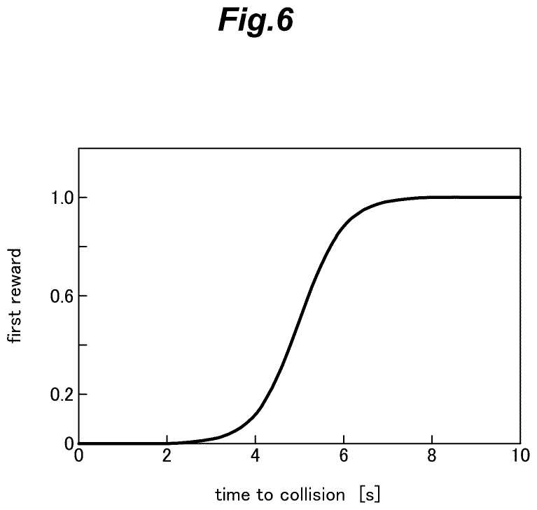

The first reward r1 is set by using the first reward function shown in FIG. 6. The first reward function outputs the first reward r1 in response to input of the time to collision TC. The first reward r1 is preferably a value greater than or equal to 0 and less than or equal to 1. The first reward function is preferably a sigmoid function or a logistic function, for example. The first reward function is preferably represented by the following formula (5), for example.

$${r}_{1} = \frac{1}{1 + {e}^{- a ( ttc + b )}} \qquad ( 5 )$$

Here, ttc is the time to collision [s], and a and b are preset hyperparameters. In the example of FIG. 6, when the time to collision is less than or equal to 2 seconds, the first reward r1 is set to 0.

The first reward r1 is given when the vehicle 2 is at the target merging position, namely, when the episode ends.

The second reward r2 is given in each state, namely, in each step of the episode. The second reward r2 is a negative reward and the value thereof preferably increases in the negative direction as the deceleration of the vehicle 2 increases. The second reward r2 is preferably set to 0 when the deceleration is 0. The second reward function outputs the second reward r2 in response to input of the deceleration of the vehicle 2. The second reward function is preferably represented by the following formula (6), for example.

$${r}_{2} = - α \times {D}^{β} \qquad ( 6 )$$

Here, D is the deceleration [m/s²], and α and β are preset hyperparameters. The deceleration may be calculated based on the difference between the current value and the previous value of the velocity of the vehicle 2.

The third reward r3 is set to increase as the target merging position is closer to the beginning point of the mergeable area 102C. The third reward r3 is set by using the third reward function. The third reward function outputs the third reward r3 in response to input of the target merging position. The third reward r3 is preferably a value greater than 0. The third reward function is preferably set based on a sigmoid function or a logistic function, for example. The third reward function is preferably represented by the following formula (7), for example.

$${r}_{3} = {R}_{3 L} + ( {R}_{3 U} - {R}_{3 L} ) \times ( 1 - \frac{1}{1 + {e}^{- c ( P + d )}} ) \qquad ( 7 )$$

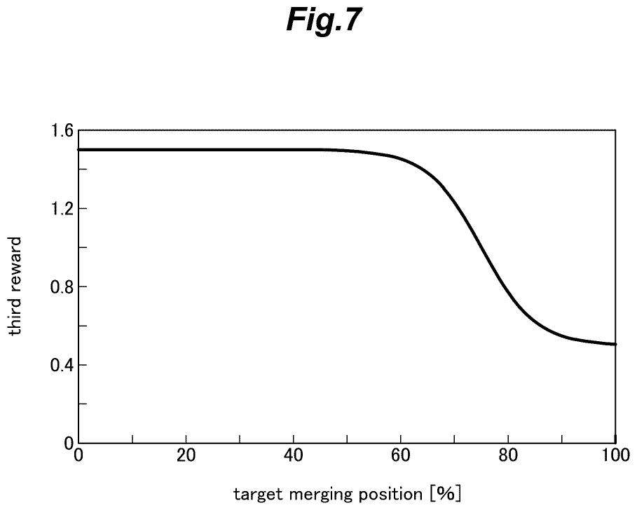

Here, R_{3L} is the lower limit value of the third reward r3, R_{3U} is the upper limit value of the third reward r3, P is the target merging position [%], and c and d are preset hyperparameters. The target merging position P is represented with the beginning point of the mergeable area 102C being 0% and the ending point of the mergeable area 102C being 100%. The third reward function is represented as shown in FIG. 7. The third reward r3 is given when the vehicle 2 is at the target merging position, namely, when the episode ends.

The fourth reward r4 is given for each state, namely, for each step of the episode. The fourth reward r4 is a negative reward, and the value thereof preferably increases in the negative direction as the difference between the current value and the previous value of the target merging position increases. The fourth reward r4 is preferably set to 0 when the difference between the current value and the previous value of the target merging position is 0. The fourth reward function outputs the fourth reward r4 in response to input of the current value and the previous value of the target merging position. The fourth reward function is preferably represented by the following formula (8), for example.

$${r}_{4} = - ε \vert {P}_{M ( S )} \to {P}_{M ( S - 1 )} \vert \qquad ( 8 )$$

Here, P_{M(s)} is the current value of the target merging position, P_{M(s-1)} is the previous value of the target merging position, and ε is a preset hyperparameter.

A reward of r2+r4 is given for each state in the episode. Also, when the episode ends, namely, when the vehicle 2 reaches the target merging position, a reward of r1×r3 is given. Since the first reward r1 and the third reward r3 are multiplied together, when the first reward r1 that is given based on the time to collision is 0, the overall reward becomes low irrespective of the value of the third reward r3. Namely, in the process of determining the target merging position, the time to collision is considered as an important factor.

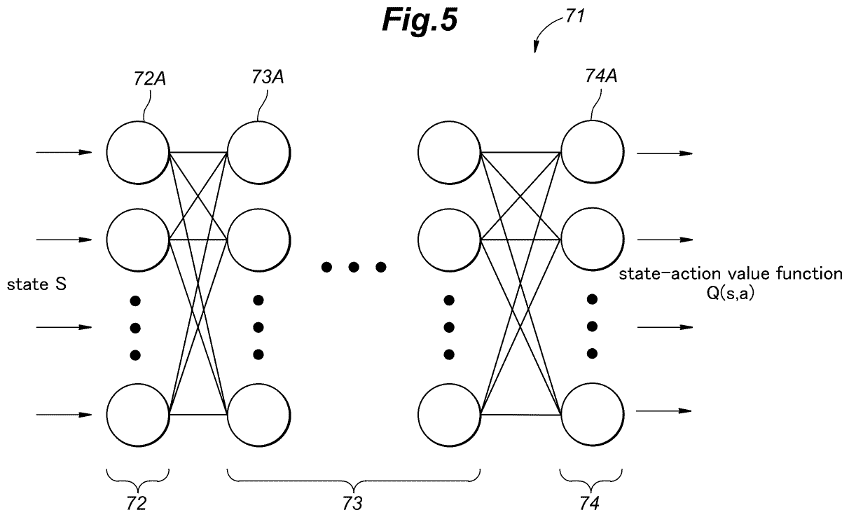

The agent 62 includes a DQN model 71. The agent 62 generates an action plan at the DQN model 71 using the state information as an input. As shown in FIG. 5, the DQN model 71 includes an input layer 72, an intermediate layer 73, and an output layer 74. The DQN model 71 approximates a Q function by using a deep neural network.

The input layer 72 includes multiple nodes 72A. These nodes 72A receive different state information as an input. The state information preferably includes the surrounding environment and the ego vehicle state. Specifically, the state preferably includes the first to sixth input data mentioned above. Preferably, the number of nodes 72A of the input layer 72 corresponds to the number of states. The input layer 72 passes the inputted information to the intermediate layer 73.

The intermediate layer 73 includes multiple layers. Each of the layers constituting the intermediate layer 73 includes multiple nodes 73A. The intermediate layer 73 compresses the information inputted to the input layer 72 and extracts a feature quantity of the information.

The output layer 74 includes multiple nodes 74A, and each node 74A outputs value information for each action. Here, each action corresponds to a target merging position. The value information is an expected value of a discounted cumulative reward obtained when a specific action is taken in a specific state, namely, a state-action value function (Q-value). The number of nodes 74A of the output layer 74 preferably corresponds to the number of actions, namely, the number of target merging positions.

In the learning using the DQN, an updating formula of the state-action value function is used as shown by the following formula (9).

$$Q ( {s}_{t} , {a}_{t} ) ← Q ( {s}_{t} , {a}_{t} ) + α ( {r}_{t + 1} + γ {max}_{{a}_{t + 1}} Q ( {s}_{t + 1} , {a}_{t + 1} ) - Q ( {s}_{t} , {a}_{t} ) ) \qquad ( 9 )$$

Here, s is the current state, a is the current action, Q(s, a) is the current state-action value function, α is a learning rate, r is a reward (immediate reward) when the action a is taken in the state s, γ is a discount factor, and maxQ(s′) is a state-action value function when an action that maximizes the value is selected in the next state s′.

The loss function (error) in the update of the Q-value may be represented by the following formulas (10) and (11) when the loss is calculated as a mean squared error, for example.

$${L}_{i} ( {θ}_{i} ) = E [ {( {Q}_{μ}^{′} ( s , a ; {θ}_{i} ) - {Q}_{π} ( s , a ; {θ}_{i} ) )}^{2} ] \qquad ( 10 )$$

$${Q}_{μ}^{′} = ( s , a ; {θ}_{i} ) = r + {γ max}_{{a}^{′}} {Q}_{π} ( {s}^{′} , {a}^{′} ; {θ}_{i} ) \qquad ( 11 )$$

Here, Li(θi) is a loss function, Qπ(s, a; θ) is a predicted value (Q-value outputted from the current model), Qu′(s, a; θ) is a value at the time of sampling (training data), and E is an expected value. In the learning using the DQN, the weights of the DQN model 71 are optimized using a backpropagation method, a gradient method, or the like, so that the loss function Li(θi) approaches zero. Namely, the parameters of the DQN model 71 are updated based on the reward and the state information, and the action plan is adjusted. The agent 62 executes the action according to the action plan, and receives the reward and the next state information from the environment 61.

The DQN model 71 with the optimized weights is used as the trained model 45 of the travel plan unit 43 of the vehicle control device 1. The trained model 45 outputs a target merging position for an input including the first to sixth input data.

The embodiment may be modified in various ways without being limited to the above-described configuration. For example, the trained model 45 may be generated based on, in addition to the first to fourth rewards r1 to r4 mentioned above, other auxiliary rewards set based on other objectives. For example, a negative reward may be given when the acceleration of the vehicle 2 becomes greater than or equal to a predetermined value. Thereby, the target merging position is set such that excessive acceleration of the vehicle 2 is suppressed. Also, a negative reward may be given when the velocity of the vehicle 2 becomes higher than or equal to a predetermined value. Thereby, the target merging position is set such that the velocity of the vehicle 2 is maintained lower than or equal to the predetermined value such as a speed limit.

The above embodiment may be described as follows.

One embodiment is a vehicle control device 1 for performing merging control of a vehicle 2, the vehicle control device 1 comprising: a surrounding environment recognition unit 41 that recognizes surrounding environment of the vehicle 2; an ego vehicle state recognition unit 42 that recognizes an ego vehicle state which is a state of the vehicle 2; a travel plan unit 43 that successively inputs the surrounding environment and the ego vehicle state to a trained model 45 that outputs a target merging position in response to input of the surrounding environment and the ego vehicle state, whereby the travel plan unit 43 successively acquires the target merging position and creates a travel plan of the vehicle 2 based on a latest value of the target merging position; and a travel control unit 44 that controls acceleration, deceleration, and steering of the vehicle 2 based on the travel plan, without relying on an operation by an occupant.

According to this aspect, since the travel plan unit 43 successively outputs the target merging position at a predetermined time interval by using the trained model 45, it is possible to set an appropriate target merging position according to the movements of the multiple nearby vehicles 200 traveling on the main lane 101.

In the above embodiment, the trained model 45 may be trained with reinforcement learning using the surrounding environment and the ego vehicle state as input data so as to output the target merging position for which a value based on a reward is maximized, and the reward may be determined based on multiple auxiliary rewards that are set according to multiple different objectives.

According to this aspect, the trained model 45 can output a target merging position capable of achieving multiple different objectives. Thus, the trained model 45 can output a target merging position that can ensure a sufficient time to collision to the nearby vehicle 200 and improve the ride comfort, for example.

In the above embodiment, the multiple auxiliary rewards may include a first reward r1 that is set to increase as a time to collision between the vehicle 2 and a nearby vehicle 200 increases, and a second reward r2 that is set to increase as a deceleration of the vehicle 2 decreases.

According to this aspect, since the auxiliary rewards used when generating the trained model 45 with reinforcement learning include the first reward, the target merging position is set such that a sufficient time to collision between the vehicle 2 and the nearby vehicle 200 is ensured at the target merging position. As a result, safety of the vehicle 2 when merging improves. Also, since the auxiliary rewards include the second reward r2, the target merging position is set such that the deceleration of the vehicle 2 during the travel to the target merging position is suppressed. As a result, the deceleration of the vehicle 2 during the travel to the target merging position is suppressed, and the ride comfort of the vehicle 2 improves.

In the above embodiment, the multiple auxiliary rewards may further include a third reward r3 that is set to increase as the target merging position is closer to a beginning point of a mergeable area 102C.

According to this aspect, the target merging position is set close to the beginning point of the mergeable area 102C. As a result, the merging is completed early, and the psychological burden on the occupant of the vehicle 2 can be reduced.

In the above embodiment, the multiple auxiliary rewards may further include a fourth reward r4 that is set to increase as a difference between a current value of the target merging position and a previous value of the target merging position decreases.

According to this aspect, the fluctuation of the updated target merging position becomes small, and the travel plan that is set based on the target merging position becomes stable. As a result, behavior of the vehicle 2 when merging becomes stable.

Another embodiment is a reinforcement learning method executed by a computer to generate a trained model 45 that outputs a target merging position in response to an input including surrounding environment of a vehicle 2 and an ego vehicle state which is a state of the vehicle 2, the reinforcement learning method comprising: acquiring state information including the surrounding environment and the ego vehicle state from a simulator; generating an action plan by a neural network using the state information as an input; executing an action according to the action plan and receiving a reward and next state information; and updating parameters of the neural network based on the reward and the state information and adjusting the action plan, wherein the reward is determined based on multiple auxiliary rewards that are set according to multiple different objectives.

According to this aspect, the reinforcement learning method can generate a trained model 45 that can successively output the target merging position based on the surrounding environment and the ego vehicle state.

Another embodiment is a reinforcement learning device 50 for generating a trained model 45 that outputs a target merging position in response to an input including surrounding environment of a vehicle 2 and an ego vehicle state which is a state of the vehicle 2, the reinforcement learning device comprising: a simulator that outputs state information including the surrounding environment and the ego vehicle state; and an agent 62 that generates an action plan by a neural network using the state information as an input, executes an action according to the action plan, receives a reward and next state information, updates parameters of the neural network based on the reward and the state information, and adjusts the action plan, wherein the reward is determined based on multiple auxiliary rewards that are set according to multiple different objectives.

According to this aspect, the reinforcement learning device 50 can generate a trained model 45 that can successively output the target merging position based on the surrounding environment and the ego vehicle state.

Another embodiment is a non-transitory computer-readable storage medium, comprising a stored program, the program configured to cause a computer to execute a reinforcement learning method for generating a trained model 45 that outputs a target merging position in response to an input including surrounding environment of a vehicle 2 and an ego vehicle state which is a state of the vehicle 2, the reinforcement learning method comprising: acquiring state information including the surrounding environment and the ego vehicle state from a simulator; generating an action plan by a neural network the state information as an input; executing an action according to the action plan and receiving a reward and next state information, updating parameters of the neural network based on the reward and the state information and adjusting the action plan, wherein the reward is determined based on multiple auxiliary rewards that are set according to multiple different objectives.

According to this aspect, the program can cause a computer to execute a reinforcement learning method for generating a trained model 45 that can successively output the target merging position based on the surrounding environment and the ego vehicle state.

1. A vehicle control device for performing merging control of a vehicle, the vehicle control device comprising:
a surrounding environment recognition unit that recognizes surrounding environment of the vehicle;
an ego vehicle state recognition unit that recognizes an ego vehicle state which is a state of the vehicle;
a travel plan unit that successively inputs the surrounding environment and the ego vehicle state to a trained model that outputs a target merging position in response to input of the surrounding environment and the ego vehicle state, whereby the travel plan unit successively acquires the target merging position and creates a travel plan of the vehicle based on a latest value of the target merging position; and
a travel control unit that controls acceleration, deceleration, and steering of the vehicle based on the travel plan, without relying on an operation by an occupant.

2. The vehicle control device according to claim 1, wherein the trained model is trained with reinforcement learning using the surrounding environment and the ego vehicle state as input data so as to output the target merging position for which a value based on a reward is maximized, and
the reward is determined according to multiple auxiliary rewards that are set based on multiple different objectives.

3. The vehicle control device according to claim 2, wherein the multiple auxiliary rewards includes a first reward that is set to increase as a time to collision between the vehicle and a nearby vehicle increases, and a second reward that is set to increase as a deceleration of the vehicle decreases.

4. The vehicle control device according to claim 3, wherein the multiple auxiliary rewards further include a third reward that is set to increase as the target merging position is closer to a beginning point of a mergeable area.

5. The vehicle control device according to claim 3, wherein the multiple auxiliary rewards further include a fourth reward that is set to increase as a difference between a current value of the target merging position and a previous value of the target merging position decreases.

6. A reinforcement learning method executed by a computer to generate a trained model that outputs a target merging position in response to an input including surrounding environment of a vehicle and an ego vehicle state which is a state of the vehicle, the reinforcement learning method comprising:
acquiring state information including the surrounding environment and the ego vehicle state from a simulator;
generating an action plan by a neural network using the state information as an input;
executing an action according to the action plan and receiving a reward and next state information; and
updating parameters of the neural network based on the reward and the state information and adjusting the action plan,
wherein the reward is determined based on multiple auxiliary rewards that are set according to multiple different objectives.

7. A reinforcement learning device for generating a trained model that outputs a target merging position in response to an input including surrounding environment of a vehicle and an ego vehicle state which is a state of the vehicle, the reinforcement learning device comprising:
a simulator that outputs state information including the surrounding environment and the ego vehicle state; and
an agent that generates an action plan by a neural network using the state information as an input, executes an action according to the action plan, receives a reward and next state information, updates parameters of the neural network based on the reward and the state information, and adjusts the action plan,
wherein the reward is determined based on multiple auxiliary rewards that are set according to multiple different objectives.

8. A non-transitory computer-readable storage medium, comprising a stored program, the program configured to cause a computer to execute the reinforcement learning method according to claim 6.
